(19) United States
(12) Patent Application Publication
(10) Pub. No.: US 2015/0047042 A1
(43) Pub. Date: Feb. 12, 2015

(54) TECHNIQUES FOR VALIDATING DISTRIBUTED DENIAL OF SERVICE ATTACKS BASED ON SOCIAL MEDIA CONTENT

(71) Applicant: INTERNATIONAL BUSINESS MACHINES CORPORATION, Armonk, NY (US)

(72) Inventors: DAVID HAIKNEY, MANCHESTER (UK); RICHARD MARSTON, MANCHESTER (UK); PATRICK VARLEY, MANCHESTER (UK)

(73) Assignee: INTERNATIONAL BUSINESS MACHINES CORPORATION, ARMONK, NY (US)

(21) Appl. No.: 14/490,904

(22) Filed: Sep. 19, 2014

Related U.S. Application Data
(63) Continuation of application No. 14/450,721, filed on Aug. 4, 2014.

(30) Foreign Application Priority Data
Aug. 9, 2013 (GB) 1314290.6

(51) Int. Cl. H04L 29/06

(52) U.S. Cl. CPC H04L 63/1408; H04L 63/1458
USPC 726/23

(57) ABSTRACT

A technique for validating a distributed denial of service attack against a computer network service associated with a computing device adapted to be connected to a computer network includes monitoring requests to the computer network service on the computer network. Social media for current trending topics or popular items is monitored to detect content directly linked to content located on the computing device or directly related to content located on the computing device. Responsive to the monitoring requests to the computer network service indicating an increased number of requests and the monitoring social media indicating that content located on the computing device or directly related to content located on the computing device is currently trending or popular, a response provided to the requests to the computer network service is modified to avoid overloading the computer network service.

This application is a continuation of application Ser. No. 14/450,721 entitled “TECHNIQUES FOR VALIDATING DISTRIBUTED DENIAL OF SERVICE ATTACKS BASED ON SOCIAL MEDIA CONTENT”, filed Aug. 4, 2014, which claims priority to United Kingdom Patent Application 1314290.6, entitled “VALIDATING DDoS ATTACKS BASED ON SOCIAL MEDIA CONTENT,” filed on Aug. 9, 2013. The disclosures of application Ser. No. 14/450,721 and United Kingdom Patent Application 1314290.6 are hereby incorporated herein by reference in their entirety for all purposes.

### BACKGROUND

The present disclosure is generally directed to computer network security and, more particularly, techniques for protecting networked computing devices against Distributed Denial of Service (DDoS) attacks from other computers by validating DDoS attacks based on social media content.

A Distributed Denial of Service (DDoS) attack can occur when a large array of remote hosts bombard a network service (typically a website) with requests with the intention of overloading that network service so it can no longer respond correctly to legitimate, standard requests. These requests usually take the form of Internet Protocol packets that trigger a flood of packets at the network service. The large number of requests overwhelms the network service's ability to respond, effectively removing the network service from being available to legitimate users by preventing it from being able to respond to legitimate, standard requests. The network service may be any device that provides such a service or any device in the path between the attacker and the network service, including storage devices, switches and routers. Such attacks can be detected by identifying a sudden significant increase in network activity.

Due to the proliferation of social media outlets (chiefly Facebook™ and Twitter™) and the significant increase in the number of users and volume of social media content there is an increasing ability to inadvertently create a DDoS scenario. Sites providing network services have an ever increasing ability to go “viral” so that the number of people wanting to legitimately access content can rise sharply in a pattern that may be indistinguishable from a traditional DDoS attack.

### BRIEF SUMMARY

Disclosed are a method, a data processing system, and a computer program product (embodied in a computer-readable storage device) for protecting networked computing devices against Distributed Denial of Service (DDoS) attacks from other computers by validating DDoS attacks based on social media content.

A technique for validating a distributed denial of service attack against a computer network service (associated with a computing device that is adapted to be connected to a computer network) includes monitoring requests to the computer network service on the computer network. Social media for current trending topics or popular items is monitored to detect content directly linked to content located on the computing device or directly related to content located on the computing device. Responsive to the monitoring requests to the computer network service indicating an increased number of requests and the monitoring social media indicating that content located on the computing device or directly related to content located on the computing device is currently trending or popular, a response provided to the requests to the computer network service is modified to avoid overloading the computer network service.

The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein:

FIG. 1 shows a general representative environment within which embodiments of the present invention may be implemented;

FIG. 2 is a block diagram of a prior art DDoS solution shown in FIG. 1;

FIG. 3 is a block diagram of a DDoS solution according to embodiments of the present disclosure;

FIG. 4 is a flow diagram of an embodiment associated with the DDoS solution of FIG. 3;

FIG. 5 is a flow diagram of another embodiment associated with the DDoS solution of FIG. 3; and

FIG. 6 shows a schematic diagram of a computer adapted to implement a DDoS validation system in accordance with an embodiment of the present disclosure.

### DETAILED DESCRIPTION

The illustrative embodiments provide a method, a data processing system, and a computer program product (embodied in a computer-readable storage medium) for protecting networked computing devices against Distributed Denial of Service (DDoS) attacks from other computers by validating DDoS attacks based on social media content.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized. As may be utilized herein, the term ‘coupled’ encompasses a direct electrical connection between components or devices and an indirect electrical connection between components or devices achieved using one or more intervening components or devices.

It would be desirable to be able to differentiate between Distributed Denial of Service (DDoS) attacks and legitimate social media usage so that a site providing a network service can modify its behavior appropriately. Embodiments of the present disclosure provide a method of validating a DDoS attack against a computer network service associated with a computing device adapted to be connectable to a computer network. In one or more embodiments, the method includes: monitoring requests to a computer network service on a computer network; monitoring social media for current trending topics or popular items to detect content directly linked to content located on a computing device or directly related to content located on the computing device; and responsive to the monitoring requests to the computer network service indicating an increased number of requests and the monitoring social media indicating that content located on the computing device or directly related to content located on the computing device is currently trending or popular, modifying the response provided to such requests so as to avoid overloading the network service. Disclose embodiments provide the advantage that the computer network service can take a more appropriate course of action in response to a sharp increase in the number of requests to the computer network service based on whether content directly linked to content located on the computing device or directly related to content located on the computing device is social media associated with current trending topics or popular items on social media.

In a preferred embodiment, the method further comprises analyzing one or more referral uniform resource locators (URLs) to detect social media referrals and responsive to the analyzing one or more referral URLs to detect social media referrals, modifying the response provided to such requests so as to avoid overloading the network service. Disclosed embodiments provide the advantage that the computer network service can take a more appropriate course of action in response to a sharp increase in the number of requests to the computer network service based on whether a referral URL indicates that the request is associated with a social media referral.

In an embodiment, the modifying the response causes more resources to be provided to support the network service. In another embodiment, the modifying the response streamlines the content to reduce workload associated with the content. In a further embodiment, the modifying throttles the response rate to give a slightly diminished but more consistent service to all users. Disclosed embodiments also provide a system for validating a DDoS attack against a computer network service associated with a computing device adapted to be connectable to a computer network. In at least one embodiment, the system comprises: a network activity monitor for monitoring requests to the computer network service on the computer network; a social media monitor for monitoring social media for current trending topics or popular items to detect content directly linked to content located on the computing device or directly related to content located on the computing device; and the computing device, responsive to the network activity monitor indicating an increased number of requests and the social media monitor indicating that content located on the computing device or directly related to content located on the computing device is currently trending or popular, modifies the response provided to such requests so as to avoid overloading the network service.

Disclosed embodiments further provide a computer program product for validating a DDoS attack against a computer network service associated with a computing device adapted to be connectable to a computer network. In one or more embodiments, the computer program product comprises: a computer-readable storage device having computer-readable program code embodied thereon. The computer-readable program code is adapted to perform the method described above when the program is run on a computer (data processing system).

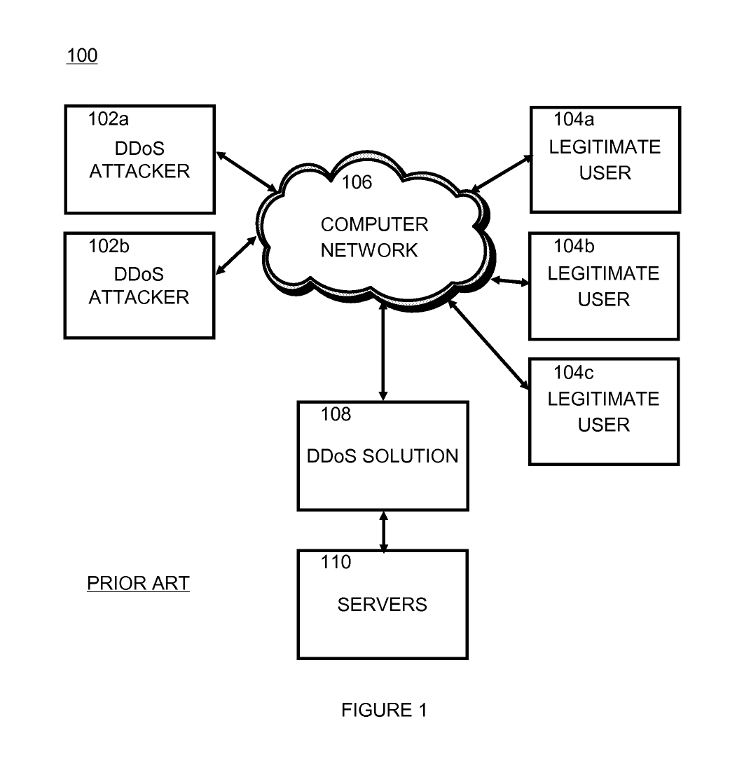

FIG. 1 shows a general representative environment within which the method, system and computer program for validating a DDoS attack against a computer network service associated with a computing device adapted to be connectable to a computer network may be implemented. Embodiments of the present disclosure are not restricted to being implemented within such an environment, which is provided for the purposes of understanding only. Referring to FIG. 1, an example environment 100 is shown. One or more DDoS attackers 102a, 102b, etc. are shown, together with one or more legitimate users 104a, 104b, and 104c. The DDoS users 102a and 102b and legitimate users 104a-104c are each connected by a network 106 via a DDoS solution 108 to one or more servers 110. The network 106 may be a private network or a public network, such as the Internet. Communication with the network 106 may be by one or more wireless networks, local area networks or mobile telephony networks or any other known network connection.

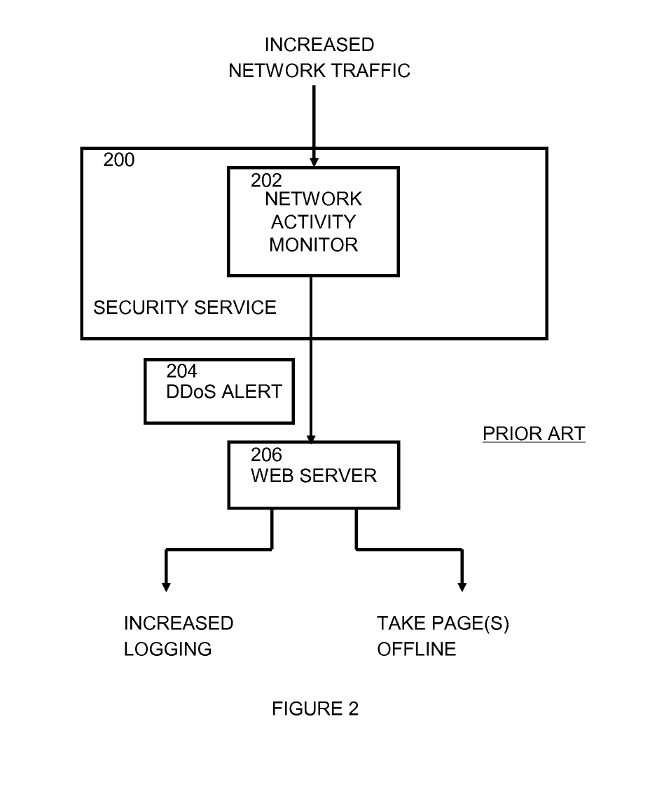

FIG. 2 shows a block diagram of a prior art DDoS solution. Security service 200 comprises network activity monitor software 202, which monitors network activity for increased traffic to and/or from the network service hosted by the web server. The security service 200 may be implemented in software or hardware, or a combination of both. The software may be implemented as firmware. An example of such a “security service” being implemented in this way is a firewall in a router, which may actually be implemented in software or hardware, or a combination of both. If a sharp increase in network traffic is detected, then a DDoS alert 204 is created. The web server 206 responds to this by one or both of increased logging of the requests or taking the relevant requested pages offline. Increasing the logging slows down the response times to legitimate requests, as well as to DDoS attacks. However, increase logging does assist the confirmation of a DDoS attack and possibly assists the identification of the DDoS attacker so as to enable filters to be put in place. Taking the page offline makes the page unavailable to legitimate users, but it does stop processing power and network bandwidth being used to return content in response to a DDoS attack.

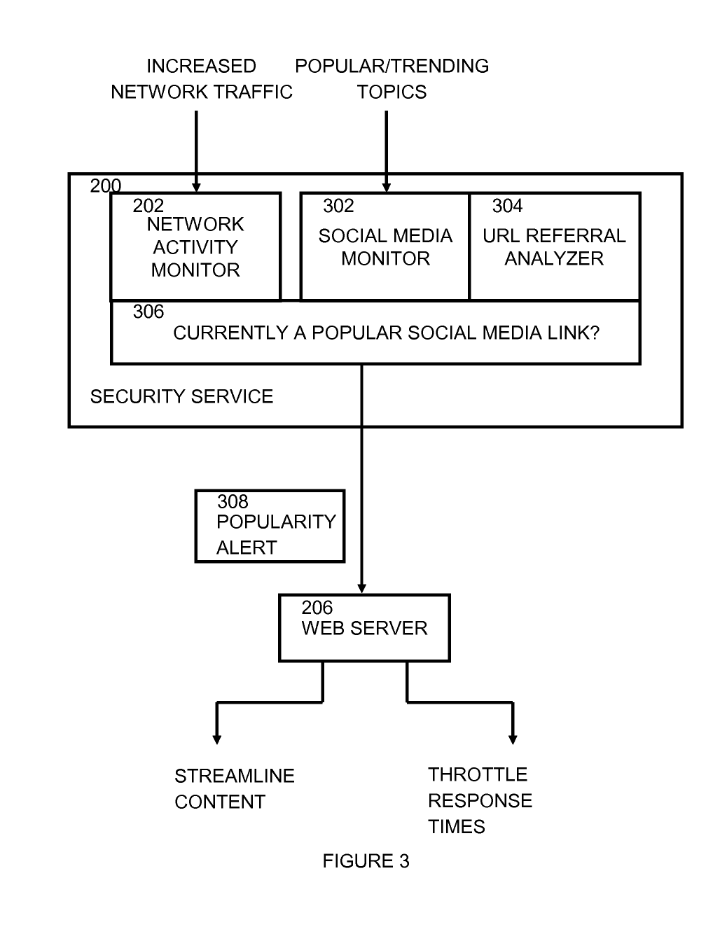

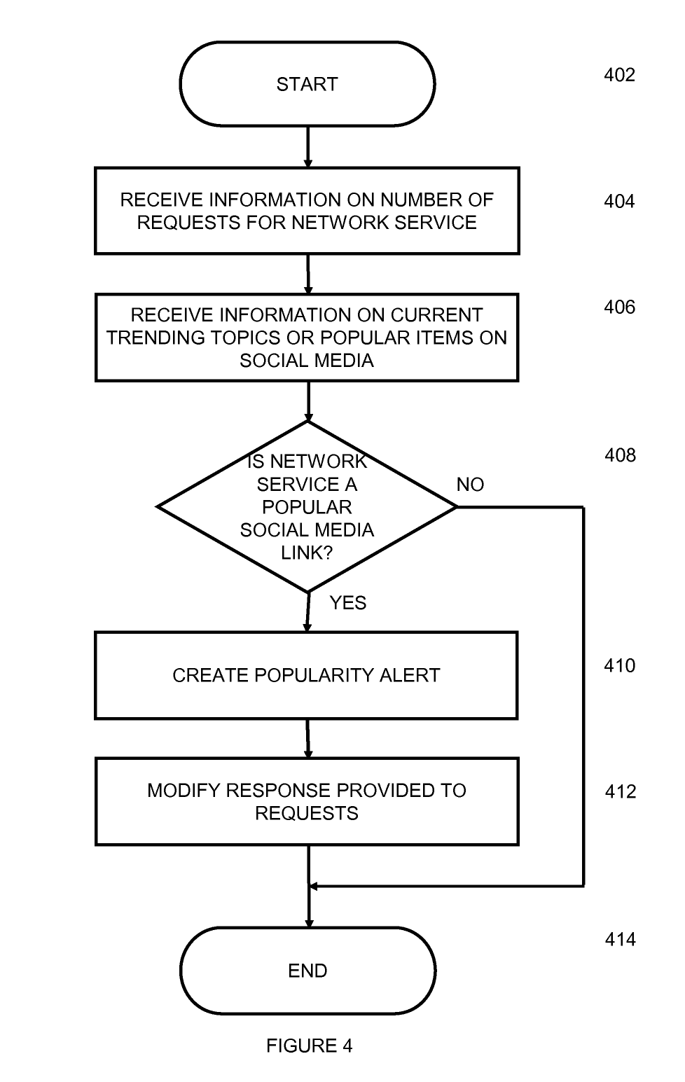

FIG. 3 is a block diagram of a DDoS solution according to embodiments of the present disclosure. FIG. 4 is a flow diagram of an embodiment of the DDoS solution of FIG. 3. A method according to an embodiment of the present disclosure starts at block 402 of FIG. 4. At block 404, network activity monitor software 202 continues to monitor network activity for increased traffic to and/or from the network service hosted by the web server. Security service 200 may further comprise social media monitor 302. Security service 200 may further comprise URL referral analyzer 304, either in addition to social media monitor 302, or as an alternative to social media monitor 302. At block 406, social media monitor 302 parses social media sites, such as Twitter, to identify currently trending topics and popular items so as to detect content either directly linking to content stored on web server 206 or content directly related to content stored on web server 206.

A trending topic is one that is tagged at a greater rate than other topics. Trending topics become popular either because of a concerted effort by users, or because of an event (often current affairs) that prompts people to talk about one specific topic. Social media monitor 302 may parse, for example, the Twitter website using the “GET trends” call of the Twitter REST API v1.1, described at https://dev.twitter.com/api/1.1#110. This call returns the top 10 trending topics for a specific geographical location or the geographical locations for which Twitter has trending topics.

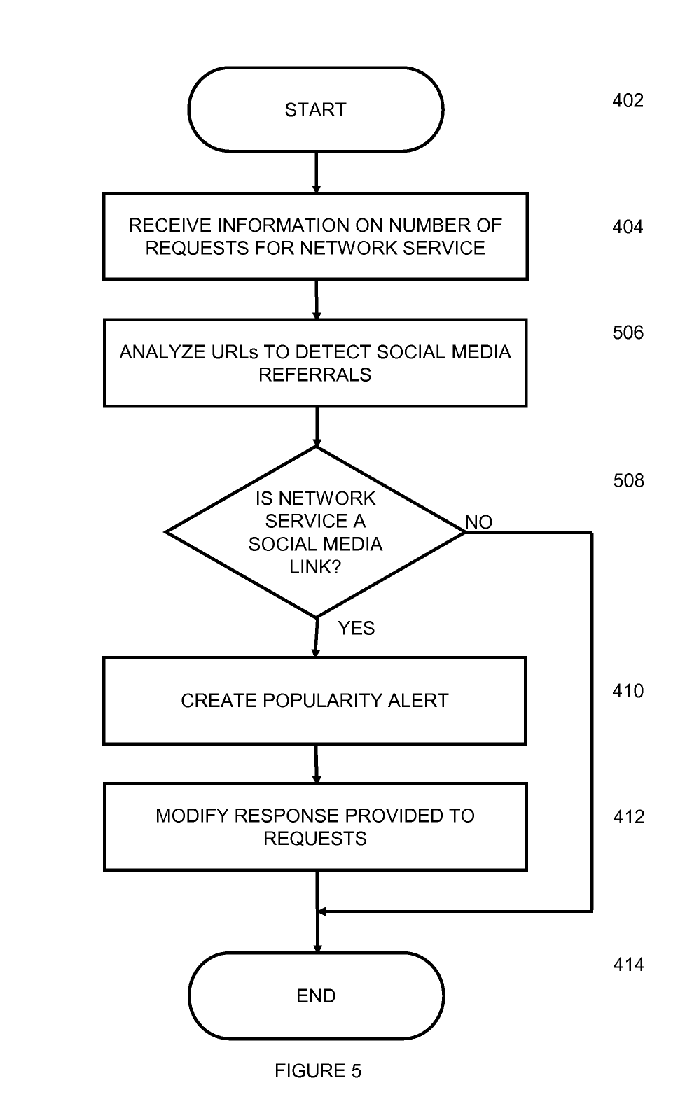

FIG. 5 is another embodiment of the DDoS solution of FIG. 3. Referring to FIG. 5, blocks 402, 404, 410, 412 and 414 are the same blocks as in the embodiment shown in FIG. 4. At block 506, URL referral analyzer 304 analyzes URLs so as to detect social media referrals. “HTTP referer” is an HTTP header field associated with a request. Although “referer” is apparently misspelled, this is the spelling used in the official HTTP specifications. It identifies the address of the source webpage that linked to the destination resource being requested. By checking the “HTTP referer” field, the destination webpage can determine from what source webpage the request originated. Typically, when a user clicks a hyperlink in a web browser, the web browser sends a request to the web server holding the destination webpage. The request includes the “HTTP referer” field, which indicates the last page the user was on (the one where they clicked the link). Referer logging is used to allow websites and web servers to identify where people are visiting them from, for promotional or statistical purposes.

HTTP Requests include header lines, sent by a client in a HTTP protocol transaction. All header lines are RFC822 format headers. The list of headers in a request is terminated by an empty line. The “HTTP Referer” optional header field allows the client to specify, for the server's benefit, the address (URL) of the document (or element within the document) from which the URL in the request was obtained. An example of an “HTTP Referer” is: Referer: http://www.w3.org/hypertext/DataSources/Overview.html. Output from the social media monitor 302 can be used at block 408 in FIG. 4 to determine 306 whether a network service (such as a web page) is currently a popular social media link. Alternatively, or in addition, output from the URL referral analyzer 304 can be used at block 508 to determine 306 whether a network service (such as a web page) is currently a popular social media link. If it is, then at block 410 a “popularity alert” 308 is created instead of a “DDoS alert” (204 in FIG. 2). The popularity alert 308 is used by the web server 206 at block 412 to modify the response provided by the web server to such requests so as to avoid overloading the network service. The method ends at block 414.

One advantage of the disclosed embodiments is that a network service can take a more appropriate course of action based on this determination. As an example, the current behavior in response to a DDoS alert may be to increase the level of logging and/or deny access to that particular network service or website. If the social media monitor 302 and/or the URL referral analyzer 304 in the security service 200 determines that the website has just become legitimately popular, then the security service 200 can cause more resources to be provided to serving this particular page, or it can streamline the web page content to reduce its workload (such as reducing the number or file size of images on page) or it can throttle the response rate to give a slightly diminished, but more consistent, service to all users. The logic to make the popularity determination can be relatively simple or complicated. It may range from “does this webpage appear in more than 100 Twitter posts?” to a complex statistical analysis of the referral URLs.

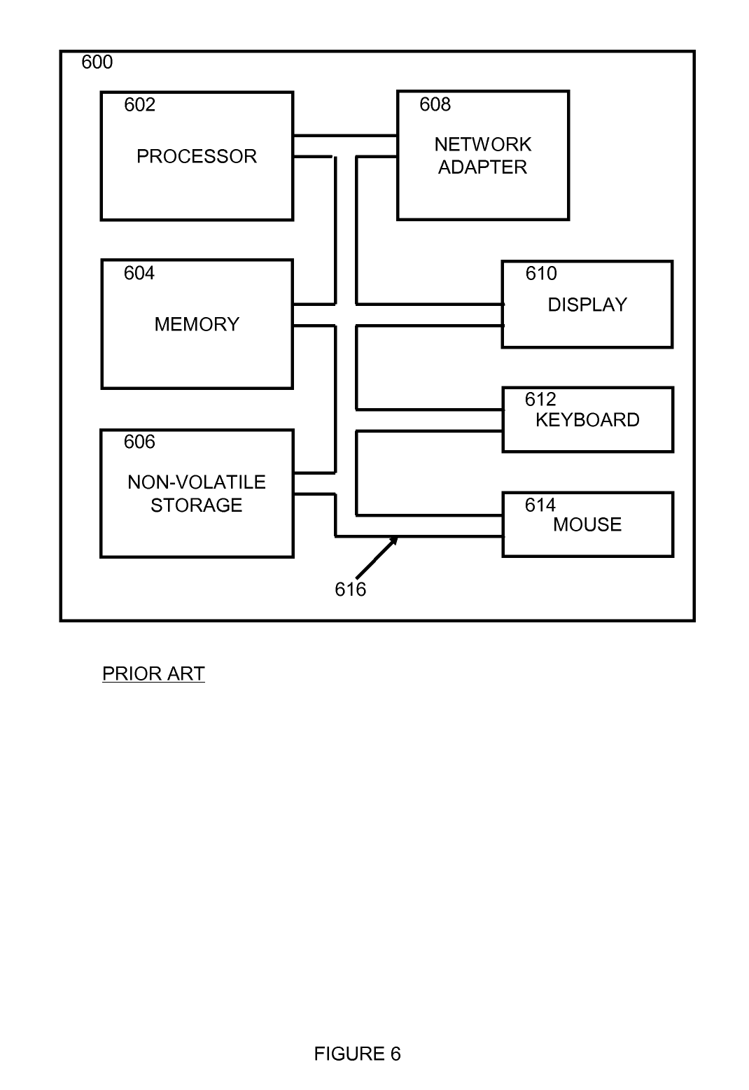

FIG. 6 shows a block diagram of an illustrative computer system in which embodiments of the present disclosure may be implemented. Bus 616 connects processor 602, memory 604, non-volatile storage 606, network adapter 608, display 610, keyboard 612 and mouse 614. Processor 602 may be a single processor or multiple processors. Memory 604 may be any computer memory used with a processor and may include multiple units of memory and/or cache memory. Non-volatile storage 606 may be a computer hard disk or electronic memory, such as flash memory. Network adapter 608 may be an adapter for connection to any network, including local networks or the Internet. It may be a wireless adapter or a wired adapter. Display 610, keyboard 612 and mouse 614 may be any conventional implementation of these items. A person skilled in the art will recognize that FIG. 6 is merely illustrative in nature and that various hardware and/or software components may be substituted or added to those shown in FIG. 6.

Accordingly, techniques have been disclosed herein for protecting networked computing devices against Distributed Denial of Service (DDoS) attacks from other computers by validating DDoS attacks based on social media content.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of validating a distributed denial of service attack against a computer network service associated with a computing device adapted to be connected to a computer network, the method comprising:
monitoring, by a processor, requests to the computer network service on the computer network;
monitoring, by the processor, social media for current trending topics or popular items to detect content directly linked to content located on the computing device or directly related to content located on the computing device; and
responsive to the monitoring requests to the computer network service indicating an increased number of requests and the monitoring social media indicating that content located on the computing device or directly related to content located on the computing device is currently trending or popular, modifying, by the processor, a response provided to the requests to the computer network service to avoid overloading the computer network service.

2. The method of claim 1, further comprising:
analyzing one or more referral uniform resource locators (URLs) to detect social media referrals; and
in response to the analyzing one or more referral URLs detecting social media referrals above a specified level, modifying the response provided to such requests so as to avoid overloading the network service.

3. The method of claim 1, wherein the modifying, by the processor, the response causes more resources to be provided to support the network service.

4. The method of claim 1, wherein the modifying, by the processor, the response streamlines the content delivered to reduce workload associated with the content.

5. The method of claim 1, wherein the modifying, by the processor, the response throttles the response rate to give a diminished but consistent service to all users.
